(19) United States
(12) Patent Application Publication
(10) Pub. No.: US 2004/0243584 A1
(43) Pub. Date: Dec. 2, 2004

(54) Control of access to computers in a computer network

(76) Inventors: Christopher W. Wesley, Redwood City, CA (US); Eric McKinlay, Cupertino, CA (US); David L. Chambers, Elkins, NH (US); Craig Zeldin, Redwood City, CA (US); Mitchell T. Weisman, San Carlos, CA (US); Mark E. Pennell, Austin, TX (US)

Correspondence Address: OKAMOTO & BENEDICTO, LLP, P.O. BOX 641330, SAN JOSE, CA, 95164, US

(21) Appl. No.: 10/816,779

(22) Filed: Apr. 2, 2004

Related U.S. Application Data
(63) Continuation-in-part of application No. 10/434,405, filed on May 8, 2003.
(60) Provisional application No. 60/457,391, filed on Mar. 25, 2003.

(51) Int. Cl. G06F 7/00

(52) U.S. Cl. 707/10

(57) ABSTRACT

In one embodiment, a blocking layer prevents a client computer without a pass from accessing a website. The blocking layer may have opaque or transparent portions, and may prevent an end-user on the client computer from interacting with the website. The pass may comprise a cookie, for example. Depending on implementation, the client computer may still be provided temporary access to the website to minimize any negative effect the blocking layer may have on website traffic. The end-user may also be provided an offer to gain permanent access to the website.

### CROSS-REFERENCE TO RELATED APPLICATIONS

The present application is a continuation-in-part of U.S. application Ser. No. 10/434,405, filed on May 8, 2003, which claims the benefit of U.S. Provisional Application Ser. No. 60/457,391, filed on Mar. 25, 2003. All of the just mentioned patent applications are incorporated herein by reference in their entirety.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

The present invention relates generally to computer systems, and more particularly but not exclusively to methods and associated systems for controlling access to computers in a computer network.

2. Description of the Background Art

As is well known, a website may be hosted in a server computer accessible over the Internet. A website may include contents such as news, products for sale, on-line services, video, audio, and other information. Just like in other media, a website may also contain advertisements to cover the cost of operating the website. For example, a web page provided to a client computer may also include banner advertisements.

As the quality and sophistication of content offered by websites increase, so does the cost of operating the websites. This prompted some websites to control access to all or some of their contents. For example, some websites require end-users to provide their e-mail address or demographic information before being allowed access to the website. Provided e-mail address may be used in an advertising campaign, while demographic information may be used to tailor advertisements displayed to end-users—both of which may help a website attract more advertisers and thereby increase its revenue.

Another way to control access to a website is to charge a subscription fee. End-users who subscribe are given a password that allows them to gain access to the website or member-only sections of the website. For example, end-users who subscribe may be able to receive streaming video or access an on-line database, whereas those who do not may only be allowed access to public sections of the website.

### SUMMARY

The present invention relates to methods and associated systems for controlling access to computers in a computer network. The present invention may be used in a variety of applications, including controlling access to one or more websites on the Internet.

In one embodiment, a blocking layer prevents a client computer without a pass from accessing a website. The blocking layer may have opaque or transparent portions, and may prevent an end-user on the client computer from interacting with the website. The pass may comprise a cookie, for example. Depending on implementation, the client computer may still be provided temporary access to the website to minimize any negative effect the blocking layer may have on website traffic. The end-user may also be provided an offer to gain permanent access to the website.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a computer network in accordance with an embodiment of the present invention.

FIG. 2 shows a flow diagram schematically illustrating control of access to a computer in a computer network, in accordance with an embodiment of the present invention.

FIG. 3 shows a flow diagram of a method of controlling access to a computer in a computer network, in accordance with an embodiment of the present invention.

FIG. 4 shows a flow diagram of a method of setting an access indicator, in accordance with an embodiment of the present invention.

FIG. 5 shows a document being displayed on a window in a client computer.

FIG. 6 shows a blocking layer being displayed over the window of FIG. 5, in accordance with an embodiment of the present invention.

FIG. 7 shows a window for displaying an offer to gain regular access to the website in accordance with an embodiment of the present invention.

FIG. 8 shows a window for displaying a message in accordance with an embodiment of the present invention.

FIG. 9 shows a flow diagram of a method of controlling access to a computer on a computer network in accordance with an embodiment of the present invention.

The use of the same reference label in different drawings indicates the same or like components.

### DETAILED DESCRIPTION

In the present disclosure, numerous specific details are provided such as examples of apparatus, components, and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

It is to be noted that although embodiments of the present invention are described herein in the context of the Internet, the present invention is not so limited and may be used in other data processing applications.

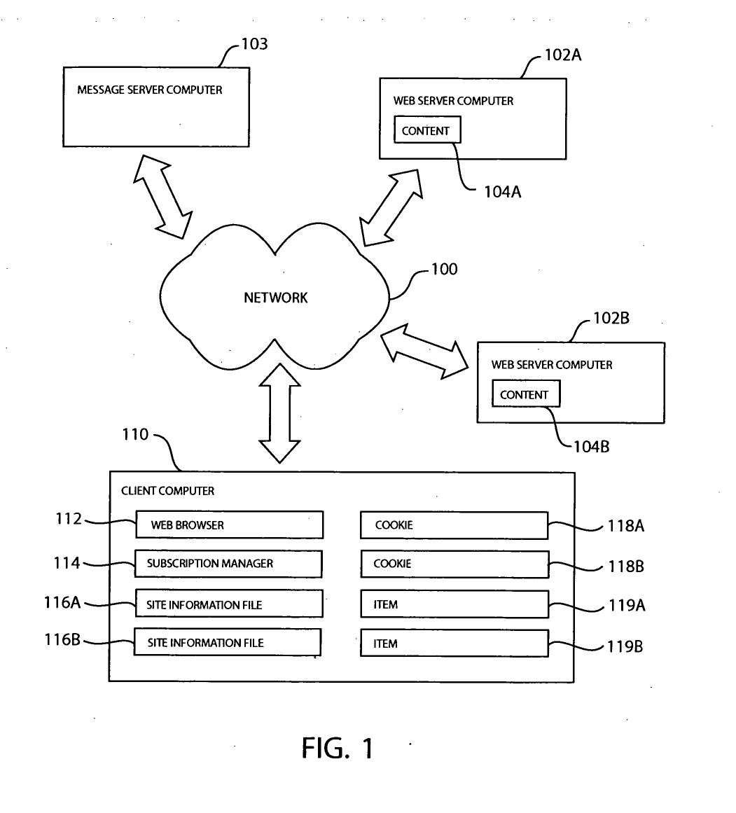

Referring now to FIG. 1, there is shown a schematic diagram of a computer network 100 in accordance with an embodiment of the present invention. Network 100 may include one or more client computers 110, one or more web server computers 102 (i.e., 102A, 102B, . . . ), one or more message server computers 103, and other computers not shown. Intermediate nodes such as gateways, routers, bridges, Internet service provider networks, public-switched telephone networks, proxy servers, firewalls, and other network components are not shown for clarity. In the example of FIG. 1, network 100 includes the Internet; however, other types of computer networks may also be used. Computers may be coupled to network 100 using any type of connection without detracting from the merits of the present invention.

A client computer 110 is typically, but not necessarily, a personal computer such as those running the Microsoft Windows™, Apple Macintosh™, Linux, or UNIX operating systems. An end-user may employ a suitably equipped client computer 110 to get on network 100 and access computers coupled thereto. For example, a client computer 110 may be used to access a content 104 (i.e., 104A, 104B, . . . ) from a web server computer 102 if the client computer 110 has the appropriate access privileges.

It is to be noted that as used in the present disclosure, the term “computer” includes any type of data processing device including personal digital assistants, digital telephones, wireless terminals, video game consoles, and the like. It is to be further noted that for purposes of the present disclosure, a computer may be a single computer or a network of computers. For example, a server computer hosting a website may comprise a single server computer, or several server computers in communication with one another.

A web server computer 102 may host a website containing information designed to attract end-users surfing on the Internet. A web server computer 102 may also include one or more contents 104, such as web pages, downloadable computer programs, products available for online purchase, voice, video, audio, wallpapers, on-line services, and the other types of information, data, or service accessible over a computer network. A web server computer 102 may also be an ad server for delivering advertisements to a client computer 110. For example, a web server computer 102 may serve banner advertisements to a web page received in a client computer 110.

In the context of the present disclosure, “accessing a website” is the same as “accessing the web server computer hosting the website”. Thus, a client computer having access privileges in a web server computer means that the end-user of that client computer has access privileges in the website hosted by that web server computer.

A message server computer 103 may include the functionalities of a web server computer 102. Additionally, in one embodiment, a message server computer 103 may also include downloadable computer programs and files for supporting, updating, or maintaining components in a client computer 110. Specifically, a message server computer 103 may include site information files 116 (i.e., 116A, 116B, . . . ) and subscription manager 114 that may be downloaded to a client computer 110. Site information files 116, subscription manager 114, and other components of a client computer 110 are further discussed below.

Examples of message server computers that may be adapted to work with embodiments of the present invention include those disclosed in the following commonly-assigned disclosures, which are incorporated herein by reference in their entirety: U.S. application Ser. No. 10/152,204, entitled “METHOD AND APPARATUS FOR DISPLAYING MESSAGES IN COMPUTER SYSTEMS”, filed by Scott G. Eagle, David L. Goulden, Anthony G. Martin, and Eugene A. Veteska on May 21, 2002; and U.S. application Ser. No. 10/289,123, entitled “RESPONDING TO END-USER REQUEST FOR INFORMATION IN A COMPUTER NETWORK”, filed by Eugene A. Veteska, David L. Goulden, and Anthony G. Martin on Nov. 5, 2002. The just mentioned commonly-assigned disclosures are referenced herein as examples and not limitations, as other types of server computers may be employed without detracting from the merits of the present invention.

Web server computers 102 and message server computers 103 are typically, but not necessarily, server computers such as those available from Sun Microsystems, Hewlett-Packard, and International Business Machines. A client computer 110 may communicate with a web server computer 102 or a message server computer 103 using client-server protocol. It is to be noted that client-server computing is well known in the art and will not be further described here.

FIG. 1 also shows some of the components of a client computer 110 in accordance with an embodiment of the present invention. In one embodiment, the components of client computer 110 shown in FIG. 1 are implemented in software. It should be understood, however, that components in the present disclosure may be implemented in hardware, software, or a combination of hardware and software (e.g., firmware). Software components may be in the form of computer programs comprising computer-readable program code stored in a computer-readable storage medium such as random access memory (RAM), mass storage device (e.g., local hard disk drive or remote hard disk drive accessible over the Internet), or removable storage device (e.g., optical storage device such as a CD-ROM or DVD). For example, a computer-readable storage medium may comprise computer-readable program code for performing the function of a particular component. Likewise, computer memory may be configured to include computer-readable program code for a particular component, which may be executed by a microprocessor. Components may be implemented separately in multiple modules or together in a single module.

Still referring to FIG. 1, a client computer 110 may include a web browser 112, a subscription manager 114, one or more site information files 116 (i.e., 116A, 116B, . . . ), one or more cookies 118 (i.e., 118A, 118B, . . . ), and one or more items 119 (i.e., 119A, 119B, . . . ). Hardware and software components not relevant to the present invention are omitted in the interest of clarity.

Web browser 112 may comprise computer-readable program code for accessing contents of a web server computer 102. Web browser 112 enables an end-user to browse and navigate over the Internet. Web browser 112 may be a commercially available web browser or web client. In one embodiment, the Microsoft Internet Explorer™ web browser is employed in a client computer 110 as web browser 112. For purposes of the present disclosure, any computer program that is not generally used by an end-user for browsing and navigation is also referred to as a “non-web browser” computer program. An example non-web browser computer program includes subscription manager 114 discussed below.

Subscription manager 114 may comprise computer-readable program code for communicating with message server computer 103. Subscription manager 114 may communicate with message server computer 103 over a TCP/IP connection, for example. Subscription manager 114 and message server computer 103 may exchange data using conventional client-server protocol. Message server computer 103 may thus provide site information files 116 to client computer 110. Similarly, subscription manager 114 may provide statistical information to message server computer 103. Examples of statistical information include the addresses (e.g., URL's) of websites visited by the end-user and the advertisements the end-user clicked on. It is to be noted that the mechanics of monitoring an end-user's browsing activity, such as determining where an end-user is navigating to, what an end-user is typing on a web page, when an end-user activates a mouse or keyboard, and the like, is, in general, known in the art and is not further described here. For example, subscription manager 114 may determine where web browser 112 is pointed to by listening for event notifications.

Subscription manager 114 may also comprise computer-readable program code for initiating the setting of a cookie 118. Subscription manager 114 may initiate the setting of a cookie 118 by having it created if it is not already in client computer 110, or by having it updated. As will be more apparent below, each web server computer 102 that has provided client computer 110 with access privileges has a corresponding cookie 118. That is, cookie 118A may be for indicating access privileges in web server computer 102A, cookie 118B may be for indicating access privileges in web server computer 102B, and so on. Subscription manager 114 may initiate the setting of cookie 118A after client computer 110 is provided access privileges in web server computer 102A. Similarly, subscription manager 114 may initiate the setting of cookie 118B after client computer 110 is provided access privileges in web server computer 102B.

Subscription manager 114 may initiate the setting of a cookie 118 by sending commands to web browser 112. In one embodiment where web browser 112 comprises the Microsoft Internet Explorer™ web browser, subscription manager 114 initiates the setting of a cookie 118 using the WinInet.dII API (application programming interface) InternetSetCookie( ). In the same embodiment, subscription manager 114 receives the contents of a cookie 118 from web browser 112 using the WinInet.dII API InternetGetCookie( ). When setting a cookie 118, subscription manager 114 tells web browser 112 the website the cookie is for and the expiration date of the cookie. Subscription manager 114 may also specify a pass-code expressed as a name-value pair to be included in a cookie 118. A pass-code allows a website to distinguish a cookie 118, which as described below may serve as an access indicator, from other cookies for that website. The pass-code may also indicate a level of access privilege (e.g., basic, premium). Web browser 112 stores a cookie 118 in accordance with the file naming and location conventions of the specific web browser and operating system employed in client computer 110.

A cookie is 118 may be set with a relatively short expiration time (e.g., 24 hours) so that it will expire if subscription manager 114 does not periodically tell web browser 112 to set it. In one embodiment, subscription manager 114 periodically initiates the setting of one or more cookies 118 as long as the client computer 110 meets one or more requirements. An example requirement includes having a site information file 116, an item 119, or both in client computer 110. Item 119 may be a computer file, a computer program, a piece of hardware (e.g., peripheral card plugged in a bus), or other types of computer component. As can be appreciated, an item 119 may be any component whose presence is detectable in client computer 110.

An item 119 may also be a computer program for delivering messages to client computer 110. For example, an item 119 may be a computer program for initiating reception of advertisements from message server computer 103 or an ad server on the Internet. In essence, client computer 110 may be allowed access to a particular web server computer 102 in exchange for the right to deliver advertisements to client computer 110; revenue from the advertisements may be used to help pay for the cost of operating the web server computer 102. Example computer programs for delivering messages to client computer 110 include message delivery programs disclosed in the above-referenced commonly-assigned disclosures. These message delivery programs are merely provided as examples, as other means for receiving advertisements in client computer 110 may be employed without detracting from the merits of the present invention.

In one embodiment, a cookie 118 serves as an access indicator. That is, a web server computer 102 may receive the contents of a cookie 118 to determine if client computer 110 has access privileges. For example, a web server computer 102 may expect a cookie 118 to contain a pass-code, such as a name-value pair “SitePass=SitepassMgr”, before providing access.

It is to be noted that cookies, in general, are known in the art and described in the Internet Engineering Task Force (IETF) document RFC 2109. In one embodiment of the present invention, setting of cookies 118 is initiated by subscription manager 114, instead of a web server computer 102. This advantageously allows subscription manager 114 to control access to several, different web server computers 102 by initiating the setting of corresponding cookies 118 (note that a web server computer 102 may only initiate the setting of its own cookies, while web browser 112 normally does not set cookies unless requested). As an economic benefit, this advantageously allows one business entity (e.g., individual, corporation, etc.), which may be the provider or creator of subscription manager 114, to promote, manage, and control access to several web server computers. That business entity may charge the operators of participating web server computers 102 for its services.

As mentioned, a site information file 116 may be downloaded from message server computer 103. A site information file 116 may also be downloaded from a web server computer 102. In one embodiment, a site information file 116 is a text file containing configuration information for a web server computer 102. In the example of FIG. 1, site information file 116A contains configuration information for web server computer 102A, site information file 116B contains configuration information for web server computer 102B, and so on. As a specific example, site information file 116A may have the following configuration information for web server computer 102A:

“[sitepass] domain=toonland.com FriendlyName=Toonland.com website RefreshIntervalHrs=1”

to indicate that the cookie for the domain name “toonland.com”, also known as the “Toonland.com website”, is to be updated every 1 hour. Subscription manager 114 may then tell web browser 112 to set cookie 118A for “toonland.com” with an expiration time of at least 1 hour. Subscription manager 114 may then periodically initiate setting of cookie 118A every hour.

In light of the present disclosure, those of ordinary skill in the art will appreciate that using subscription manager 114 to control access to web server computers 102 provides advantages heretofore unrealized. In addition to being able to control access to several web server computers, subscription manger 114 is also uniquely capable of determining whether client computer 110 is meeting a requirement. Specifically, because of security provisions in most web browsers, a typical web server computer 102 is not capable of detecting whether an item 119 remains in client computer 110. In contrast, subscription manager 114, being a client computer program, can determine if an item 119 remains in client computer 110 by performing a file search, for example. This ensures that an end-user who is provided access to a website in exchange for the promise to retain an item 119 (which may be an advertisement or a computer program for receiving advertisements) in client computer 110 actually does so. Subscription manager 114 will not initiate the setting of a corresponding cookie 118 if it detects that the required item 119 is no longer in client computer 110, thereby causing cookie 118 to expire and revoking the end-user's access privileges in the website.

In one embodiment, subscription manager 114 has its own program group, uninstall, and icon in client computer 110. This readily allows an end-user to find where subscription manager 114 is located and, if necessary, use the uninstall to remove subscription manager 114 and associated files, such as site information files 116. Preferably, the end-user is provided the option to uninstall individual site information files 116, to be able to cancel membership in specific websites. Program groups, uninstalls, and icons are well known components of client computers running the Microsoft Windows™ operating system.

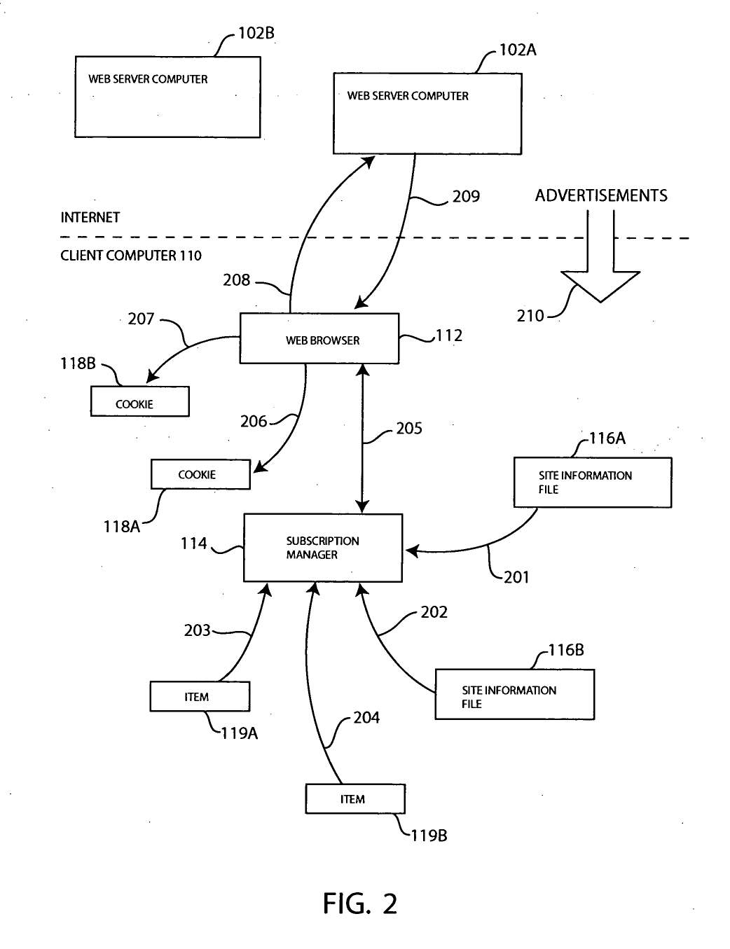

FIG. 2 shows a flow diagram schematically illustrating control of access to a computer in a computer network, in accordance with an embodiment of the present invention. As indicated by arrows 201 and 202, subscription manager 114 reads site information files 116 available in client computer 110 to determine how to configure cookies 118. Thereafter, subscription manager 114 detects for the presence of item 119A, item 119B, or both in client computer 110 (see arrows 203 and 204). In this example, the presence of item 119A, item 119B, or both is a requirement for accessing all or certain sections of web server computer 102A. The requirement for accessing a web server computer 102 may be obtained from a corresponding site information file 116. For example, the requirement to have item 119A to access web server computer 102A may be stored in site information file 116A.

Subscription manager 114 tells web browser 112 (see arrow 205) to set cookies 118 based on configuration information obtained from corresponding site information files 116. Cookie 118A is set (see arrow 206) in accordance with configuration information obtained from site information file 116A, cookie 118B is set (see arrow 207) in accordance with configuration information obtained from site information file 116B, and so on. In this example, subscription manager 114 initiates the updating of cookie 118A every hour to prevent it from expiring. When web browser 112 sends an access request to web server computer 102A (see arrow 208), web browser 112 uploads the contents of all cookies intended for web server computer 102A along with the access request. The uploaded contents include those of cookie 118A, which web server computer 102A examines to determine if client computer 110 has any access privileges. Based on the contents of cookie 118A, web server computer 102A provides a response (see arrow 209) to client computer 110. The response may include a web page, a multi-media file, access to an on-line database, streaming video, a voice-over-IP connection, etc.

A web server computer 102 may restrict access to all sections or certain sections of the web server computer 102. For example, web server computer 102A may host a website that only allows access to end-users with access privileges. The website may also have public sections and member-only sections. The public sections may provide “basic services” such as capability to view web pages that contain general information, while the member-only sections may provide “premium services” such as capability to view streaming video, listen to MP3 music, or view web pages containing special information (e.g., stock market tips). Cookie 118A may indicate the kind of service a client computer 110 (and hence the end-user) is authorized to access.

As indicated by arrow 210, advertisements may be delivered in client computer 110 so long as it retains access privileges in web server computer 102A, web server computer 102B, or both. The advertisements may be incorporated in web pages provided by web server computer 102A. In the example of FIG. 2, the requirement for allowing access to web server computer 102A includes retaining item 119A, which may be a client computer program for receiving advertisements from an ad server (not necessarily web server computer 102A) over the Internet. However, the requirement may also simply be keeping subscription manager 114, site information file 116A, or both in client computer 110.

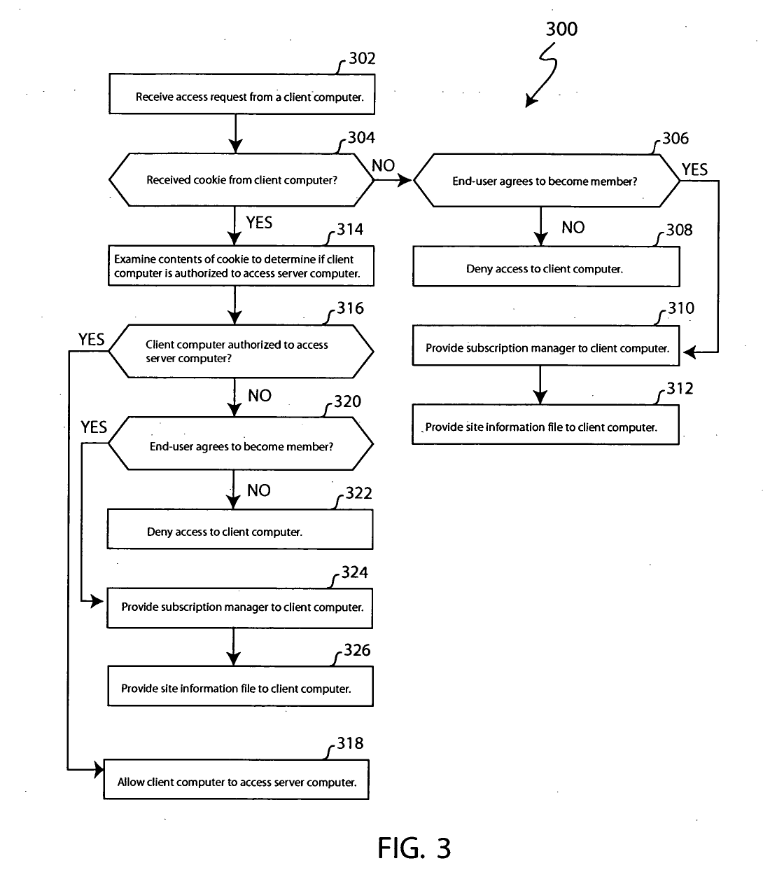

FIG. 3 shows a flow diagram of a method 300 for controlling access to a computer in a computer network, in accordance with an embodiment of the present invention. Method 300 describes the steps performed by a web server computer. As can be appreciated, method 300 may also be re-written to describe the steps performed by a client computer. For example, web server computer steps that recite “receiving” may be re-written to recite “sending” to describe corresponding steps performed by a client computer.

Starting in step 302, a web server computer receives an access request from a client computer. The access request may be a request to download a document, such as a web page or a file, or access a service, for example. In step 304, the web server computer determines if a cookie serving as an access indicator has been received from the client computer. Not receiving a cookie from the client computer indicates that the end-user of the client computer is not a registered member, and is thus not authorized to access all or certain sections of the website hosted by the web server computer. In that case, the end-user is given the opportunity to become a member of the website. To become a member, the end-user may have to explicitly agree to a license agreement requiring the end-user to keep certain items in the client computer, to receive advertisements from various sources, or both. For example, the end-user may be required to click on a license agreement to explicitly agree to receive advertisements in exchange for access privileges. Making the end-user explicitly agree to receive advertisements (as opposed to just displaying advertisements to the end-user) advantageously helps prevent confusion as to the source of advertisements, and also helps ensure that the end-user understands the conditions for having access privileges in the website.

Note that in the context of the present disclosure, “receiving a cookie” is the same as receiving the contents of the cookie. That is, a web server computer does not necessarily have to receive a file comprising a cookie.

In steps 306 and 308, the client computer is denied access to the web server computer (or sections of the web server computer) if the end-user does not want to become a member. In steps 306, 310, and 312, a subscription manager is downloaded to the client computer along with a site information file for the web server computer if the end-user agrees to become a member.

Continuing in step 314, the web server computer examines the contents of the cookie to determine if the client computer has access privileges. A cookie not containing expected information (e.g., missing a pass-code, such as “SitePassMgr”) indicates that the cookie is not authentic, or is not for purposes of gaining access to the web server computer. In that case, the end-user may be asked to sign up for membership to receive a subscription manager and a site information file, as indicated in steps 320, 324, and 326. In steps 320 and 322, the client computer is denied access if the end-user does not want to become a member.

In steps 316 and 318, the client computer is allowed access to the web server computer commensurate with the client computer's access privileges.

In method 300, the site information file is obtained from the web server computer after the end-user signs up for membership. It is to be noted, however, that site information files may also be obtained from a message server computer or another web server computer. For example, referring back to FIG. 1, the end-user of client computer 110 may download subscription manager 114 and site information file 16B from message server computer 103 to gain access to a website hosted by web server computer 102B. Thereafter, the end-user may gain access privileges in a website hosted by web server computer 102A by downloading site information file 116A from message server computer 103 without having to download another subscription manager 114. As can be appreciated, once subscription manager 114 is downloaded to client computer 110, the end-user merely has to download additional site information files 116 to obtain access privileges in other websites.

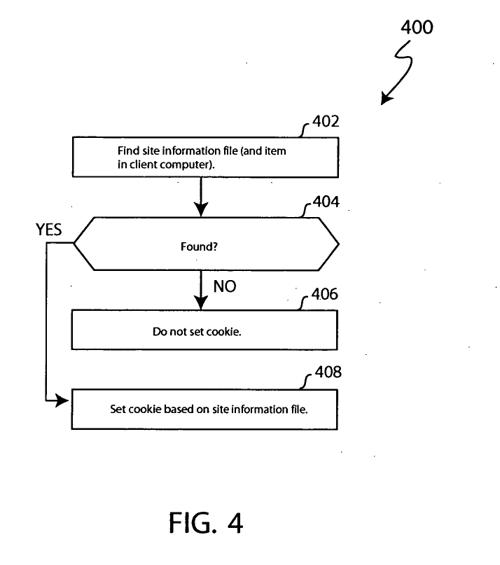

FIG. 4 shows a flow diagram of a method 400 for setting an access indicator, in accordance with an embodiment of the present invention. In embodiments disclosed herein, cookies are employed as access indicators. As can be appreciated by those of ordinary skill in the art reading the present disclosure, however, other types of files or mechanisms for holding data may also be employed in lieu of cookies. Starting in step 402, a subscription manager finds a site information file and, optionally, one or more required items in a client computer. In steps 404 and 406, a cookie serving as an access indicator for accessing a web server computer is not set if a corresponding site information file and the required item are not found in the client computer. Not setting a cookie may include not creating a cookie if it does not exist in the first place, or not updating a pre-existing cookie. Otherwise, as indicated in steps 404 and 408, a cookie is set based on configuration information contained in the site information file. Setting a cookie may include creating a cookie if it does not exist, or updating a pre-existing cookie. In one embodiment, a cookie is set by having a client program (e.g., subscription manager 114) request a web browser to do so.

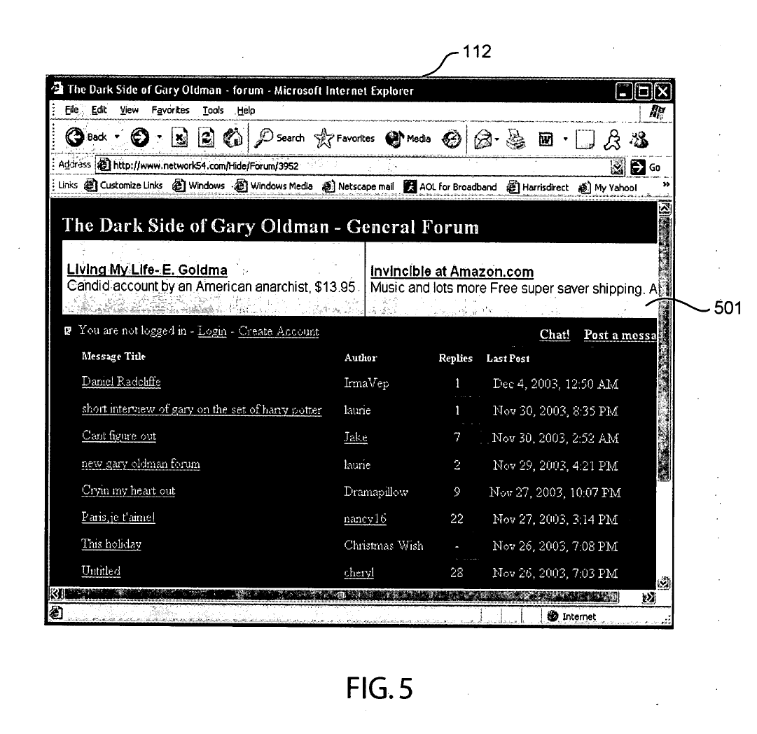

Other techniques for controlling access to computers in a computer network are now described beginning with FIG. 5. The following embodiments are described using websites on the Internet as examples, not limitations.

FIG. 5 shows a document displayed on a window in a client computer. In the example of FIG. 5, the document is a web page 501 while the window is that of a web browser 112 (see also FIG. 1). Web page 501 may be one of several from a website on the Internet. An end-user on client computer 110 (see FIG. 1) may receive web page 501 by pointing web browser 112 to the website. In the example of FIG. 5, the website provides a forum on the Internet. As can be appreciated, embodiments of the present invention may also be employed with other types of websites without detracting from the merits of the present invention.

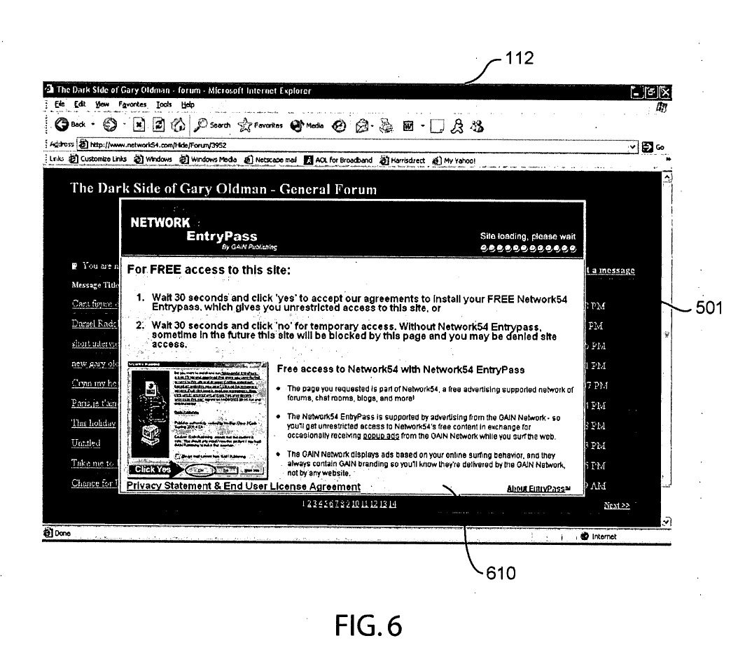

FIG. 6 shows a blocking layer 610 being displayed over web page 501, in accordance with an embodiment of the present invention. Blocking layer 610 prevents the end-user from interacting with the web site. For example, blocking layer 610 prevents the end-user from clicking on any portion of web page 501. Note that blocking layer 610 may have opaque and transparent portions. In the example of FIG. 6, the opaque portions of blocking layer 610 are those that cover web page 501, while the transparent portions are those over the still visible portions of web page 501. In one embodiment, blocking layer 610 is overlaid on web page 501 in memory. An example pseudo code for creating a blocking layer 610 is shown in Table 1.

TABLE 1
Create a DIV (aka HTML Layer), fill the DIV with desired content,
append the DIV to the document, and position the DIV within the
browser window over the viewable web site content.
function blockPage () {

wait for document to fully load;
layer = document->createObject ( DIV );
layer->content = HTML for desired content;
document->appendObject ( layer );
layer->resize ( browserWindow->size );
layer->position ( atop current browser content );

}

Blocking layer 610 may intercept end-user interaction with visible and non-visible portion of web page 501 to prevent the end-user from accessing web page 501 or other documents on the website.

In one embodiment, blocking layer 610 is displayed on client computers 110 that do not have authorization to access the website. Such authorization may be in the form of a pass, such as a cookie containing a pass-code, for example. In the example, of FIG. 6, client computer 110 does not have a pass to access the website. Blocking layer 610 may advantageously include provisions and instructions for gaining access to the website.

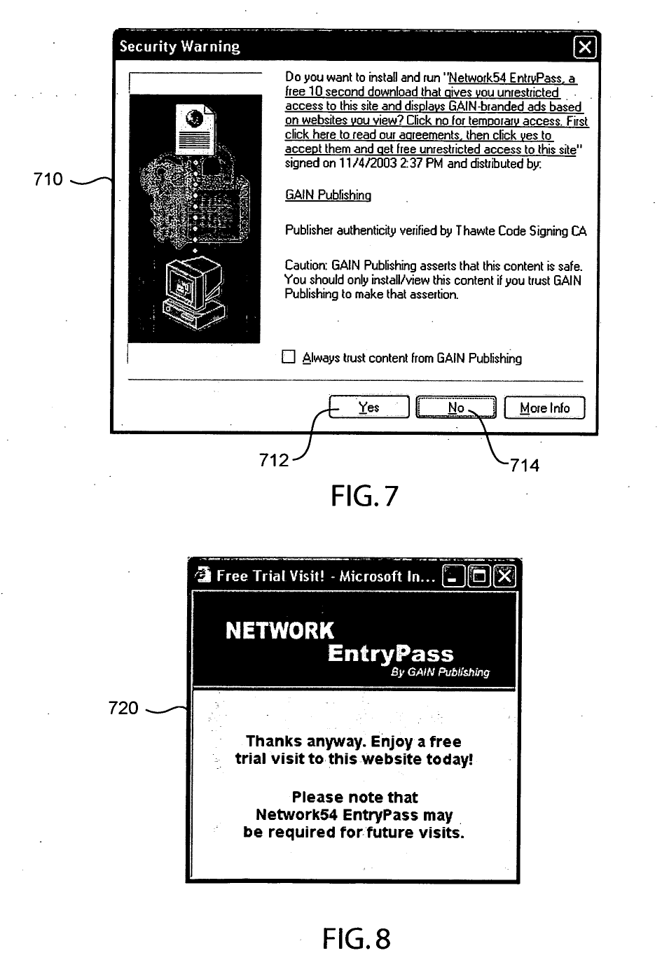

FIG. 7 shows a window 710 for displaying an offer to gain regular access to the website in accordance with an embodiment of the present invention. Window 710 may be displayed over blocking layer 610 a few seconds after blocking layer 610 is displayed. In the example of FIG. 7, window 710 comprises a security prompt that is also known as a Verisign™ prompt. Window 710 may be displayed using a browser plug-in, for example. Window 710 may include a YES button 712, which the end-user may click on to accept the offer. The end-user may click on a NO button 714 to decline the offer.

FIG. 8 shows a window 720 for displaying a message in accordance with an embodiment of the present invention. Window 720 is displayed when the end-user clicks on the NO button 714 of FIG. 7. In the example of FIG. 8, window 720 indicates that the end-user may still gain temporary access to the website. However, that temporary access may be revoked in the future. In essence, the end-user is provided a free trial visit in the hopes that the end-user may like the website and later decide to receive a regular pass in exchange for receiving advertisements. This also minimizes any negative effect the access control may have on the website's traffic.

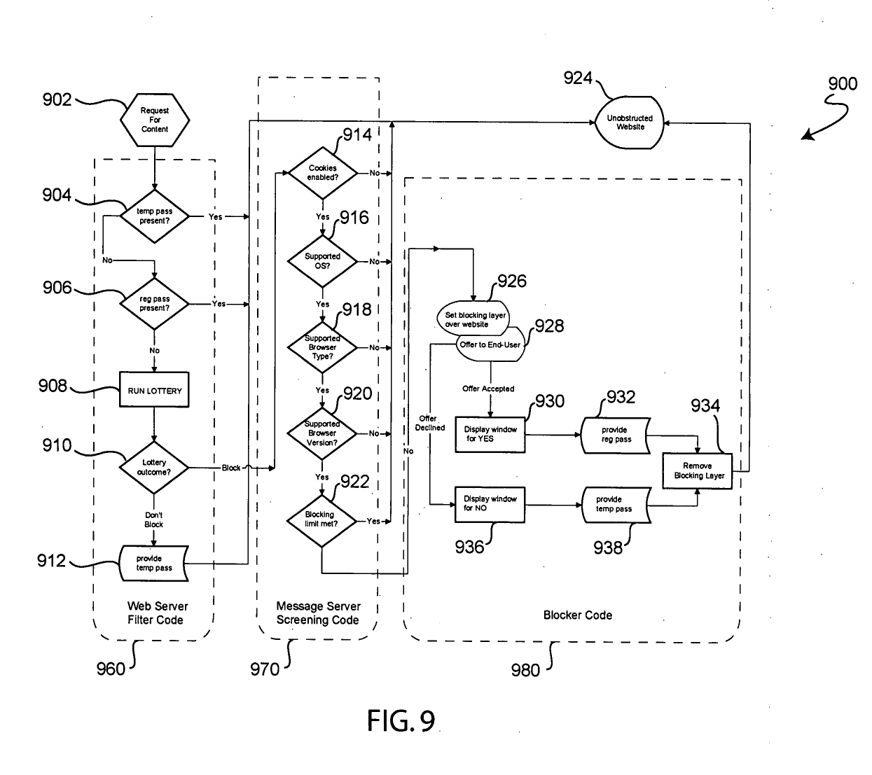

FIG. 9 shows a flow diagram of a method 900 of controlling access to a computer in a computer network in accordance with an embodiment of the present invention. In one embodiment, method 900 is implemented in software. As can be appreciated method 900 may also be implemented in hardware or combination of hardware and software (e.g., firmware), depending on the application. In one embodiment, method 900 comprises a web server filter code 960, a message server screening code 970, and a blocker code 980.

Filter code 960 may comprise computer-readable program code for determining whether to set up a blocking layer (e.g., blocking layer 610) on a website. In one embodiment, filter code 960 is stored on the web server computer (e.g., a web server computer 102 shown in FIG. 1) hosting the website. A web page of the web site may include a reference to filter code 960. When the web page is received in a client computer (e.g., a client computer 110 shown in FIG. 1), the reference is executed in the client computer to pull filter code 960 from the web server computer to the client computer. In the client computer, filter code 960 performs a series of tests to determine whether or not to block the client computer from accessing the website. If filter code 960 determines that the client computer may need to be blocked, filter code 960 may request a message server computer for blocker code 980. In the example of FIG. 9, steps 904, 906, 908, 910, and 912 may be performed by filter code 960. An example filter code 960 implemented in the JavaScript programming language is shown in Appendix A of this disclosure.

Message server screening code 970 may comprise computer-readable program code for determining if the client computer is suitable to receive blocker code 980. Screening code 970 may reside in and be executed by a message server computer (e.g., message server computer 103 shown in FIG. 1). Upon receipt of a request for blocker code 980, screening code 970 may first perform a series of tests to determine if blocker code 980 is compatible with the client computer. The results of the tests may be based on information received from the client computer. For example, HTTP headers received from the client computer may allow screening code 970 to determine the operating system and type of web browser of the client computer. In one embodiment, the client computer is not blocked if it is not suitable to receive and run blocker code 980. This advantageously prevents improper operation of the blocker code in the client computer. It is to be noted that depending on the application, the client computer may also be blocked if it is not suitable to receive blocker code 980. In that case, access to the website is limited to client computers that are compatible with blocker code 980 and have a pass. In the example of FIG. 9, steps 914, 916, 918, 920, and 922 may be performed by screening code 970.

Blocker code 980 may comprise computer-readable program code for controlling access to the website. Blocker code 980 may reside in a message server computer. Depending on the results of the tests performed by screening code 970, the message server computer may provide blocker code 980 to the client computer. Blocker code 980 is then executed by the client computer. In one embodiment, blocker code 980 blocks access to the website if the client computer does not have a regular or temporary pass to access the website. Blocker code 980 may also provide the end-user an offer to gain access to the website in the event the client computer does not have a pass to the website. In the example of FIG. 9, steps 926, 928, 930, 932, 934, 936, and 938 may be performed by blocker code 980. An example blocker code 980 implemented in the JavaScript programming language is shown in Appendix B of this disclosure.

Method 900 begins in step 902 when the client computer submits a request for content to the web server computer hosting the website. The request for content in this example is for a web page. In response to the request, the web server computer may provide the web page to the client computer. That web page may include a reference to filter code 960, which may be stored in the web server computer. When the computer-readable program code (e.g., HTML) of the web page is executed at the client computer, the reference is also executed and thereby pulls filter code 960 to the client computer. Filter code 960 is then executed by the client computer.

In steps 904 and 906, filter code 960 searches the client computer for a temporary or regular pass for accessing the website. In one embodiment, the temporary or regular pass comprises a cookie. In that case, filter code 960 communicates with the web browser in the client computer to locate and read the contents of the cookie, if any. The client computer is allowed to access the website if it has a temporary or a regular pass, as indicated in the paths from step 904 to step 924 and from step 906 to step 924. Otherwise, in step 908, a “lottery” is run to randomly determine if the client computer is to be provided access to the website even without any pass. The lottery may be implemented using a random number generator, for example. Randomly determining if the client computer is to be allowed access even without a pass minimizes any negative effect the access control may have on website traffic. This is especially advantageous in situations where the website is fairly new or has not generated enough traffic to warrant full restricted access. As can be appreciated, running such a lottery is optional.

Going through the path from step 910 to step 912, the client computer is provided a temporary pass to access the website if the result of the lottery so indicates. Otherwise, filter code 960 initiates blocking of the client computer by requesting the message server for a blocker code.

Going through the path from step 910 to step 914, the message server executes screening code 970 to determine if the client computer is suitable to receive the blocker code. In step 914, screening code 970 determines if cookies are enabled in the client computer. In one embodiment, step 914 is performed in the message server by attempting to write a cookie in the client computer. If the writing of the cookie fails, this would indicate that the client computer does not accept cookies. In embodiments where a cookie is employed as a pass to the website, blocker code 980 may not properly work in the client computer. Accordingly, in the path from step 914 to step 924, the website is not blocked if cookies are not enabled in the client computer.

In step 916, screening code 970 determines if the client computer is running an operating system that is compatible with blocker code 980. If so, screening code 970 continues to step 918. Otherwise, the website is not blocked.

In step 918, screening code 970 determines if the web browser in the client computer is the correct browser type (e.g., brand of web browser) for blocker code 980. For example, in one embodiment, the website is not blocked if the web browser is not the Microsoft Internet Explorer™ web browser. In step 920, screening code 970 determines if the web browser is a version supported by blocker code 980. In one embodiment, the website is not blocked if the web browser is either the wrong type or the wrong version, as indicated in the paths from step 918 to step 924 and from step 920 to step 924. Note that the operating system, browser type, and browser version of the client computer may be determined from a packet header (e.g., HTTP header) received from the client computer when the client computer requested for a blocker code.

In step 922, screening code 970 determines if the number of blocked client computers has exceeded a predetermined threshold number. The threshold number may correspond to the number of client computers that may be blocked from accessing the website within a given period of time. This advantageously prevents excessive blocking of website traffic. Step 922 may be performed by counting the number of times blocker code 980 has been downloaded to client computers. If the number of client computers blocked form accessing the website is equal to or exceeds the threshold, then the client computer is provided access to the website, as indicated in the path from step 922 to step 924. Otherwise, blocker code 980 is provided to and executed in the client computer.

In step 926, blocker code 980 sets a blocking layer (e.g. blocking layer 610 shown in FIG. 6) over the website. The blocking layer serves as a barrier for preventing the end-user from interacting with the website. For example, the blocking layer may prevent the end-user from actuating (e.g., clicking with a mouse) the links of a web page of the website.

In step 928, blocker code 980 provides the end-user an offer to gain regular access to the website. The offer may be displayed on a window (e.g., see window 710 shown in FIG. 7) having buttons for accepting or declining the offer. If the end-user accepts the offer, another window acknowledging the acceptance may be displayed to the end-user as indicated in step 930. Accordingly, blocker code 980 initiates installation of a regular pass in the client computer and removal of the blocking layer, as indicated in steps 932 and 934.

If the end-user does not accept the offer, another window (e.g., window 720 shown in FIG. 8) acknowledging the non-acceptance may be displayed to the end-user as indicated in step 936. In step 938, the client computer is provided a temporary pass to access the website even when the offer is declined. In that case, the blocking layer is removed to allow the client computer to access the website as indicated in the path from step 938 to step 934. Depending on the application, the client computer may also be prevented from accessing the website if the end-user declines the offer.

In one embodiment, blocker code 980 initiates installation of a temporary pass by pulling an authorization web page from the web server computer hosting the website. The authorization web page may comprise-computer readable program code for setting a cookie that serves as a temporary pass. The temporary pass cookie is created when the authorization web page is received in the client computer. An example authorization web page implemented in HTML is shown in Appendix C.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A method of controlling access to a website, the method comprising:
receiving a request for a web page from a client computer;
searching the client computer for a pass to the website; and
if the client computer does not have a pass to the website, setting a blocking layer having an opaque portion over the website such that an end-user on the client computer cannot interact directly with the website.

2. The method of claim 1 further comprising:
if the client computer does not have a pass to the website, randomly determining if the client computer should be provided temporary access to the website instead of setting the blocking layer over the website.

3. The method of claim 1 further comprising:
if the client computer has a pass to the website, allowing the end-user to interact with the website instead of setting the blocking layer over the website.

4. The method of claim 1 wherein at least a portion of the blocking layer is transparent and allows viewing of portions of the website.

5. The method of claim 1 wherein the blocking layer blocks a majority of the website from view and prevents the end-user from interacting with any portion of the website.

6. The method of claim 1 wherein the pass to the web site comprises a cookie.

7. The method of claim 1 wherein searching the client computer for a pass to the website comprises looking for a cookie at the client computer and examining the cookie at the client computer.

8. The method of claim 1 wherein the blocking layer allows the end-user to view a portion of the website but does not allow the end-user to activate a link on that portion.

9. The method of claim 1 further comprising:
if the client computer does not have a pass to the website, determining if the client computer is running a supported operating system; and
if the client computer is not running a supported operating system, providing the client computer temporary access to the website instead of setting the blocking layer over the web site.

10. The method of claim 1 further comprising:
if the client computer does not have a pass to the website, determining if the client computer is running a supported web browser; and
if the client computer is not running a supported web browser, providing the client computer temporary access to the website instead of setting the blocking layer over the web site.

11. The method of claim 1 further comprising:
if the client computer does not have a pass to the website, displaying an offer to gain access to the website; and
if the end-user does not accept the offer to gain access to the website, providing the client computer temporary access to the website.

12. The method of claim 1 further comprising:
if the client computer does not have a pass to the website, determining if cookies are enabled in the client computer; and
if cookies are not enabled in the client computer, providing the client computer temporary access to the website instead of setting the blocking layer over the web site.

13. The method of claim 1 further comprising:
if the client computer does not have a pass to the web site, displaying an offer to gain access to the website; and
if the end-user accepts the offer to gain access to the website, providing the client computer regular access to the web site.

14. A method of controlling access to a server computer, the method comprising:
receiving a request for a document from a client computer;
providing the document to the client computer;
determining if the client computer is authorized to access documents on the server computer; and
if the client computer is not authorized to access documents on the server computer, preventing an end-user on the client computer from interacting with the document.

15. The method of claim 14 further comprising:
if the client computer is not authorized to access documents on the server computer, randomly determining if the client computer should be provided temporary access to documents on the server computer instead of preventing the end-user on the client computer from interacting with the document.

16. The method of claim 14 wherein preventing the end-user from interacting with the document comprises displaying a blocking layer over the document.

17. The method of claim 14 further comprising:
if the client computer is not authorized to access documents on the server computer, displaying a security prompt offering to gain access to documents on the server computer; and
if the end-user does not accept the offer to gain access to documents on the server computer, providing the client computer temporary access to documents on the server computer.

18. The method of claim 14 further comprising:
if the client computer is not authorized to access documents on the server computer, displaying a security prompt offering to gain access to documents on the server computer; and
if the end-user accepts the offer to gain access to documents on the server computer, providing the client computer regular access to documents on the server computer.

19. The method of claim 14 wherein the document comprises a web page and the server computer is hosting a website.

20. A system for controlling access to a server computer, the system comprising:
a first server computer including a document downloadable over a computer network, the document including a reference to a filter code configured to determine if a client computer has a permission to access documents on a website;
a second server computer including a blocker code, the blocker code being configured to control access to documents on the website; and
a client computer configured to receive the document and the filter code, the filter code being configured to pull the blocker code from the second server computer to the client computer if the client computer does not have permission to access documents on the website, the blocker code being configured to run in the client computer to block the computer from accessing documents on the website.

21. The system of claim 20 wherein the blocker code is further configured to offer an end-user on the client computer regular access to documents on the website.

22. The system of claim 20 wherein the filter code is further configured to randomly determine whether to pull the blocker code instead of outright pulling the blocker code into the client computer.

23. The system of claim 20 wherein the filter code is stored in the first server computer.

24. The system of claim 20 wherein the documents comprise web pages and the computer network comprises an Internet.
